(19) United States
(12) Patent Application Publication
(10) Pub. No.: US 2015/0054914 A1
(43) Pub. Date: Feb. 26, 2015

(54) 3D Content Detection

(71) Applicant: Amlogic Co. Ltd., Santa Clara, CA (US)

(72) Inventors: Dongjian Wang, San Jose, CA (US); Xuyun Chen, San Jose, CA (US)

(73) Assignee: Amlogic Co. Ltd., Santa Clara, CA (US)

(21) Appl. No.: 14/010,442

(22) Filed: Aug. 26, 2013

(51) Int. Cl. H04N 13/00

(52) U.S. Cl. CPC H04N 13/0007
USPC 348/43

(57) ABSTRACT

A method for 3D content detection, comprises the steps of: receiving a frame of video data comprising cells, wherein the cells are partitioned into a first area and a second area, and wherein the cells of the first area and the cells of the second area have one or more video characteristics; comparing the video characteristics of the cells of the first area with the video characteristics of the cells of the second area; and determining whether the frame has 3D content as a function of the compared video characteristics of the cells.

### FIELD OF INVENTION

This invention generally relates to three-dimensional (“3D”) content detection, and, in particular, to detection of 3D content in video data and for determining the type of 3D frame format.

### BACKGROUND

A three-dimensional (“3D”) video (or a stereoscopic image or a stereoscopic film) is implemented by presenting separate views of an image to each of the viewer's eyes. One example of a 3D video implementation used in television is referred to as a polarized 3D system, which uses polarization glasses to create an illusion of three-dimensional images by only allowing different polarizations of light to reach each eye of a viewer. In this manner, the viewer is presented with a different view of an image for each eye. The brain perceives the different views for each eye as depth. Thereby, the 3D system can provide a 3D image or video to the viewer.

Specifically, for a polarized 3D system, two images are superimposed onto the same screen or display through different polarizing filters. The viewer wears eyeglasses which contain a pair of different polarizing filters for each eye. As each filter passes only that light which is similarly polarized and blocks the light polarized in the opposite direction, each eye sees a different image. This is used to produce a 3D effect by viewing the same image into both eyes, but depicted from slightly different perspective views.

In order for a 3D video data to be viewed, the 3D video data must be transmitted to the television (or other display device). In particular, two stereo views of the video data must be received by the television and decoded. For the television to properly display the 3D video data, the viewer must manually place the television in a 3D processing mode by navigating the television menus or the television must have some means of automatically detecting for 3D video content. Unless the 3D mode is enabled either by the viewer or automatically by the television, the 3D video data may not be properly processed and reliably displayed on the television.

Furthermore, even when the 3D mode for the television is automatically detected or enabled, it may be difficult for the television to discern the frame format used to pack the 3D video data. Typically, frame compatible formats refer to a class of stereo video formats in which the two stereo views are essentially multiplexed into a single coded frame or sequence of frames, i.e., a first view and a second view are packed together in the samples of a single video frame. In such a format, half of the coded samples represents the first view and the other half represents the second view. Thus, each coded view has half the resolution of the full coded frame.

There are a variety of options available for how the packing can be performed. For example, FIG. 1a illustrates a top-bottom frame format for 3d video data. A top-bottom frame format has samples x of a first view that are packed on a top portion of the frame and samples o of a second view that are packed on a bottom portion of the frame, hence the name top-bottom frame format. During viewing of the frame, the first view and the second view are superimposed on the television for stereo viewing, e.g., by a polarization system.

FIG. 1b illustrates a side-by-side frame format for 3D video data. A side-by-side frame format has samples x of a first view that are packed on a right portion of the frame and samples o of a second view that are packed on a left portion of the frame.

FIG. 1c illustrates a column-interlaced frame format for 3d video data. A column-interlaced frame format has samples x of a first view that are positioned on the even numbered columns of the frame and samples o of a second view that are positioned on the odd numbered columns of the frame. Thus, the samples for the first view and the second view alternate for each adjacent column of the frame.

FIG. 1 d illustrates a row-interlaced frame format for 3d video data. A row-interlaced frame format has samples x of a first view that are positioned on the even numbered rows of the frame and samples o of a second view that are positioned on the odd numbered rows of the frame. Thus, the samples for the first view and the second view alternate for each adjacent row of the frame.

FIG. 1e illustrates a checkerboard-interlaced frame format for 3d video data. A checkerboard-interlaced frame format has samples x of a first view and samples o of a second view that are positioned in alternating fashion along each of the rows of the frame and each of the columns of the frame. Thereby, a checkerboard pattern is provided for the frame, hence the name of the frame format.

FIG. 1f illustrates a 2D frame format having a single view. In a two-dimensional (“2D”) frame format, the frame format has a single view, i.e., samples x. Thus, all the samples x are related to that single view.

The primary benefit of frame-compatible formats is that they facilitate the introduction of stereoscopic services through existing infrastructure and equipment. Representing the stereo video in a way that is compatible with existing encoding, decoding and delivery infrastructure, e.g., over-the-air broadcasting systems, is the major advantage of these 3D frame formats. The 3D video data can be compressed with existing encoders, transmitted through existing channels, and decoded by existing receivers. However, legacy devices designed for monoscopic content may not recognize the format and may therefore incorrectly display the frame-packed video (e.g. both views simultaneously side-by-side rather than superimposing two views for generating a stereoscopic image or video).

Therefore, it would be desirable to provide systems and methods that facilitate automatic detection of 3D content in a video program signal and automatically switch the display mode of the television for 3D video display. Furthermore, it is desirable to provide systems and methods for 3D content detection that discern the type of frame format used to pack the 3D video content.

### SUMMARY OF INVENTION

An object of this invention is to provide methods for quickly detecting whether 3D video content is present in a signal.

Another object of this invention is to provide methods for determining a frame format for 3D video data.

Yet another object of this invention is to provide methods for calculating a metric representative of the reliability for 3D content detection in a signal.

Briefly, the present invention discloses a method for 3D content detection, comprises the steps of: receiving a frame of video data comprising cells, wherein the cells are partitioned into a first area and a second area, and wherein the cells of the first area and the cells of the second area have one or more video characteristics; comparing the video characteristics of the cells of the first area with the video characteristics of the cells of the second area; and determining whether the frame has 3D content as a function of the compared video characteristics of the cells.

An advantage of this invention is that methods and systems for quickly detecting whether 3D video content is present in a signal are provided.

Another advantage of this invention is that methods for determining a frame format for 3D video data are provided.

Yet another advantage of this invention is that methods for calculating a metric representative of the reliability for 3D content detection in a signal are provided.

### DESCRIPTION OF THE DRAWINGS

The foregoing and other objects, aspects, and advantages of the invention can be better understood from the following detailed description of the preferred embodiment of the invention when taken in conjunction with the accompanying drawings in which:

FIGS. 1a-1f illustrate frame formats for 3D and 2D video data.

FIG. 2 illustrates a frame of video data having multiple cells in an array format.

FIGS. 3a-3b illustrate cells in a row of a frame used for calculating a sum of absolute differences and an inverse sum of absolute differences for the row.

FIGS. 4a-4b illustrate cells in a column of a frame for calculating a sum of absolute differences and an inverse sum of absolute differences for the column.

FIG. 5 illustrates a method of the present invention for determining whether 3D content is packed in video data.

FIG. 6 illustrates a method of the present invention for determining whether 3D content is interlaced into video data.

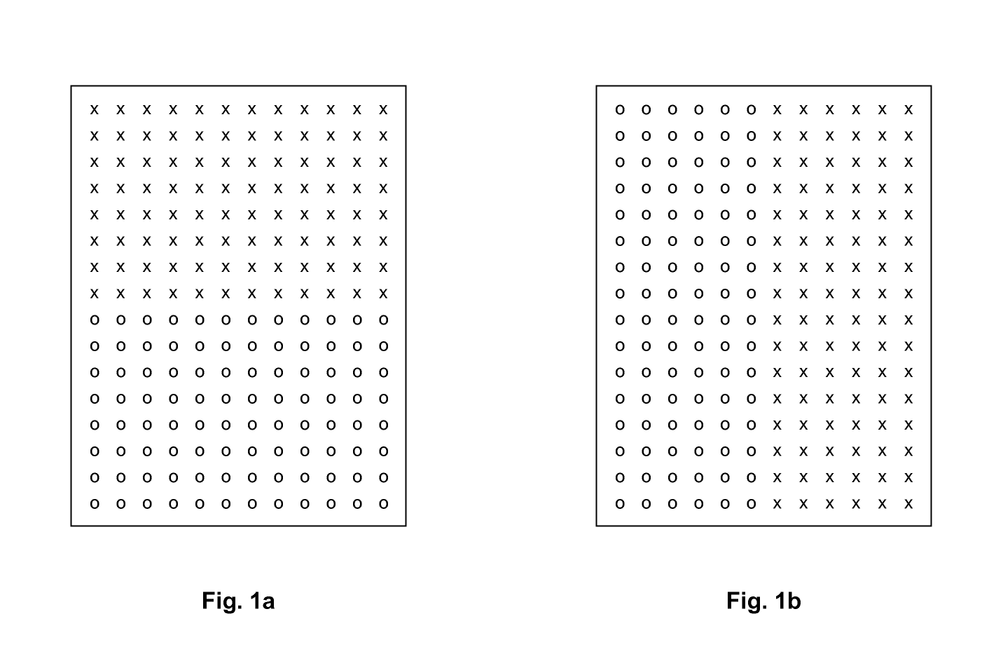

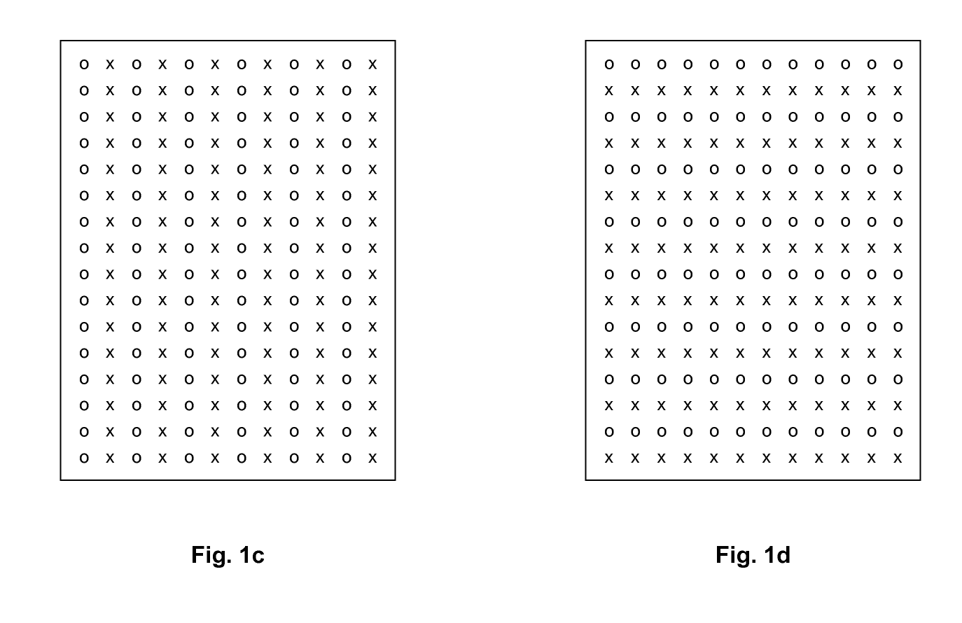

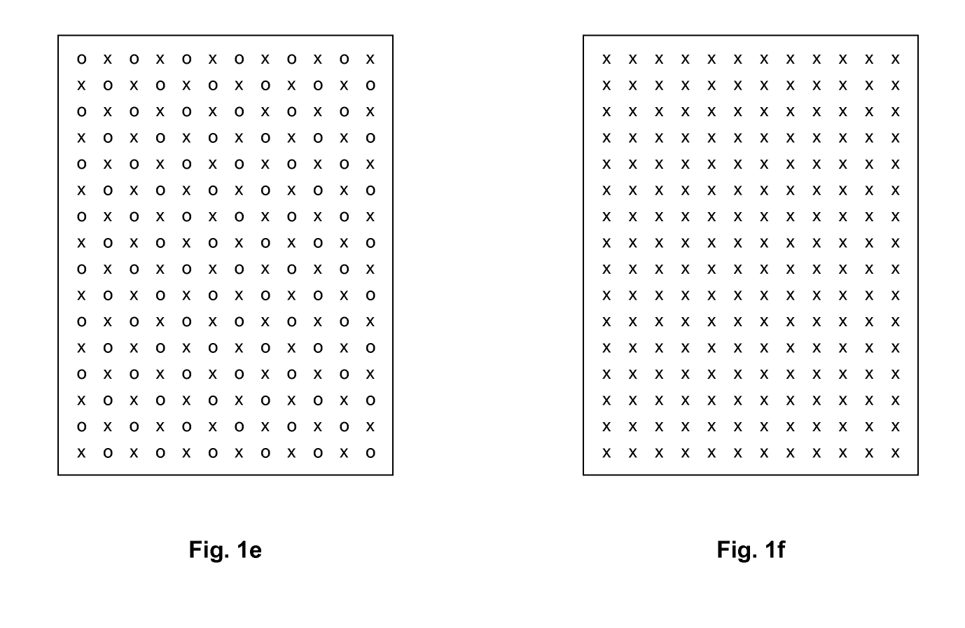

### DETAILED DESCRIPTION OF THE PREFERRED EMBODIMENTS

In the following detailed description of the embodiments, reference is made to the accompanying drawings, which form a part hereof, and in which is shown by way of illustration of specific embodiments in which the present invention may be practiced.

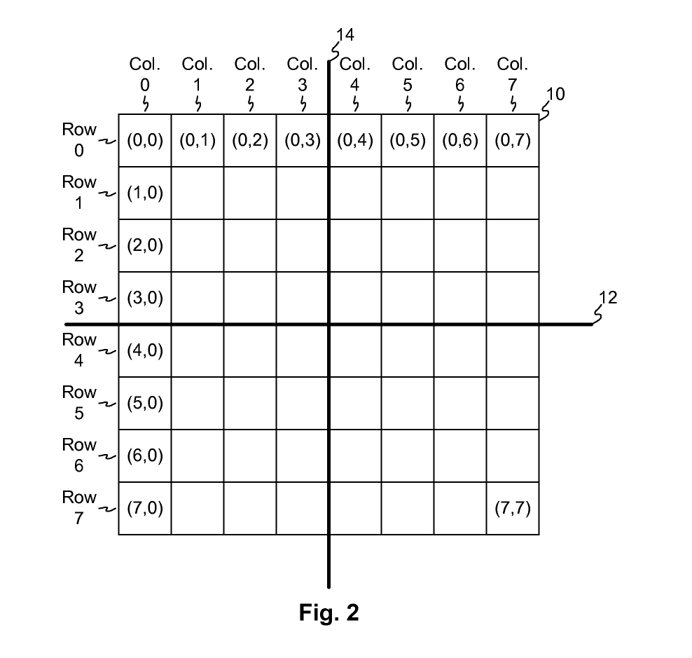

FIG. 2 illustrates a frame of video data having multiple cells in an array format. A frame 10 of video data can be partitioned into several cells in an array format. The array can comprise eight rows (e.g., row 0 through row 7) and eight columns (e.g., col. 0 through col. 7). Thus, the cells can be identified by its row and column number. For instance, the cell (0,0) represents the cell in row 0 and col. 0, the cell (1,0) represents the cell in row 1 and col. 0, the cell (7,7) represents the cell in row 7 and col. 7, etc.

Each of the cells can comprise multiple samples, e.g., pixels, of the frame. The samples of a cell can be processed for generating video characteristics data, including the average luminosity (or luma) for the cell, the average chroma value for the cell, motion detection in the cell, edge detection within the cell, etc. The average luma value for the cell can be calculated by averaging the luma values for each sample of the cell. Similarly, the average chroma value can be calculated by averaging the chroma values for each sample of the cell. Motion detection and edge detection for the cell can also be performed on the cell. As well, other video characteristics data can be calculated for the cell for use in comparing cells. A person having ordinary skill in the art can employ known methods for determining other video characteristic data over a bounded region of samples, e.g., a cell. Thus, the video characteristics data can represent various aspects for each of the cells.

The frame 10 can be bisected into two areas, a first area and a second area, along either a bisecting line 12 or a bisecting line 14. The areas can have equal area size and equal number of cells. The cells in the first area are compared with the cells in the second area in a predefined manner to determine whether the frame 10 has 3D video data. If 3D video data is detected, then the frame format can be determined, e.g., if the 3D data is in a side-by-side frame format or a top-bottom frame format.

The first area can comprise cells to one side of the bisecting line 14 including all the cells in the columns 0-3. The second area can comprise cells to the other side of the bisecting line 14, including all the cells in the columns 4-7. The cells in the first area and the cells in the second area that are in the same row can be compared. For instance, the calculated video characteristics of one cell in the first area can be compared to the calculated video characteristics of one cell in the second area. In particular, the cells in the two different areas along the same row can be compared to indicate if there's a 3D frame format for the video data, and if the type of 3D frame format, if any, is in a top-bottom frame format.

Alternatively, the comparison of one area to another area can be performed row by row. For instance, a first area can comprise cells to one side of the bisecting line 12 including all the cells from the rows 0-3. A second area can comprise cells to the other side of the bisecting line 12, including all the cells from the rows 4-7. The cells in the first area and the cells in the second area that are in the same column can be compared. For instance, the calculated video characteristics of one cell in the first area can be compared to the calculated video characteristics of one cell the cells in the second area, where these cells are in the same column. The comparison of the cells in the two different areas along the same column can indicate if there's a 3D frame format, and the type of 3D frame format used, if any.

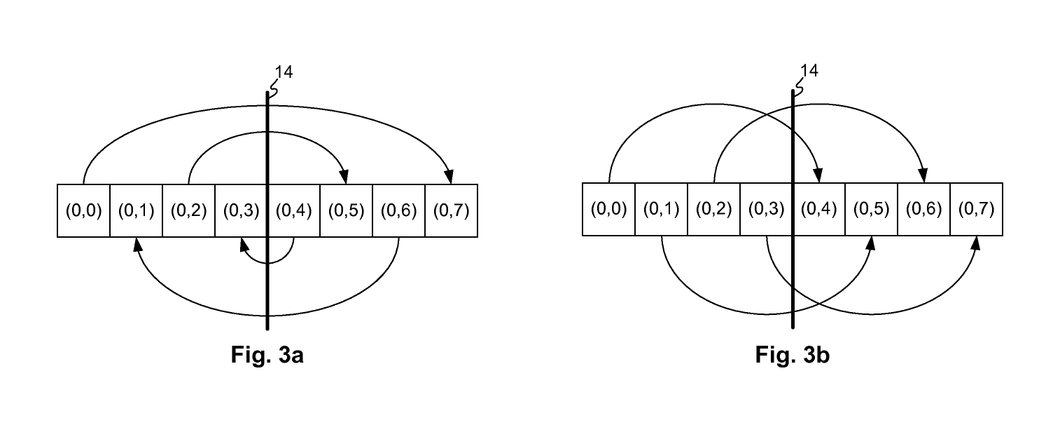

FIG. 3a illustrates a row of a frame for calculating a sum of absolute differences for the cells of the row. Generally, a cell in a first area of the frame is compared to a cell in a second area of the frame to determine how similar or dissimilar the first area is with the second area. In order to do this, for each row a sum of absolute differences (“SAD”) for the cells in the same row are calculated. The larger the SAD value for a row, the more likely the respective frame has 3D video data. Furthermore, all the SAD values from the other rows of the frame can be calculated and summed to generate a single SAD sum for the rows of the frame.

The SAD value is calculated by first calculating the differences between a cell in the first area and a cell in the second area, i.e., a mirrored counterpart, that is in a mirror image position about the bisect line 14, and then repeating this step for all the cells in the first area. All the differences are summed up to get the SAD value for the row. For instance, a video characteristics of the cell (0,0) is subtracted with the video characteristics of the cell (0,7); the video characteristics of the cell (0,1) is subtracted with the video characteristics of the cell (0,6); the video characteristics of the cell (0,2) is subtracted with the video characteristics of the cell (0,5); and the video characteristics of the cell (0,3) is subtracted with the video characteristics of the cell (0,4). The video characteristics can be a single characteristic, for instance, the average luminosity for each cell. Thus, the subtracting of average video characteristic values for the cells can be the basis for comparing those cells, e.g., by subtracting the average luminosity of one cell with the average luminosity of another cell at a predefined position. The differences for the cells in that row are summed together to get a SAD value for that row of the frame.

FIG. 3b illustrates a row of a frame for calculating an inverse sum of absolute differences for the cells of the row. In addition, other cell positions can be compared to determine how similar or dissimilar the first area is with the second area. In order to do this, for each row an inverse sum of absolute differences (“ISAD”) for the cells in the same row are calculated. The smaller the ISAD value for a row, the more likely the respective frame has 3D video data. Furthermore, all the ISAD values from the other rows of the frame can be calculated and summed to generate a single ISAD sum for the rows of the frame.

The ISAD value is calculated by first calculating the differences between a cell in the first area and a cell in the second area that is disposed in the same position as the cell in the first area from the bisect line 14, and then repeating this step for all the cells in the first area. All the differences are summed up to get the ISAD value for the row. For instance, a video characteristics of the cell (0,0) is subtracted with the video characteristics of the cell (0,4); the video characteristics of the cell (0,1) is subtracted with the video characteristics of the cell (0,5); the video characteristics of the cell (0,2) is subtracted with the video characteristics of the cell (0,6); and the video characteristics of the cell (0,3) is subtracted with the video characteristics of the cell (0,7). The video characteristics can be a single characteristic, for instance, the average chroma for each cell. Thus, the subtracting of average video characteristic values can be the basis for comparing those cells, e.g., by subtracting the average chroma of one cell with the average chroma of another cell at a predefined position. The differences for the cells in that row are summed together to get the ISAD value for that row of the frame.

The SAD and ISAD values for the rows of the frame can determine whether the frame has 3D content packed in a side-by-side frame format. For instance, if the SAD value exceeds a first predefined threshold and the ISAD value is below a second predefined threshold, then a side-by-side frame format is detected for the television, or other display device, to initiate processing of such 3D content in accordance with the side-by-side frame format. The first predefined threshold and the second predefined threshold can be found by empirical study. These thresholds can be varied depending on the video statistics used in the SAD and ISAD calculations. For instance, threshold values can be different for SAD and ISAD calculations based on color space statistics compared to threshold values for SAD and ISAD calculations based on edge or motion statistics.

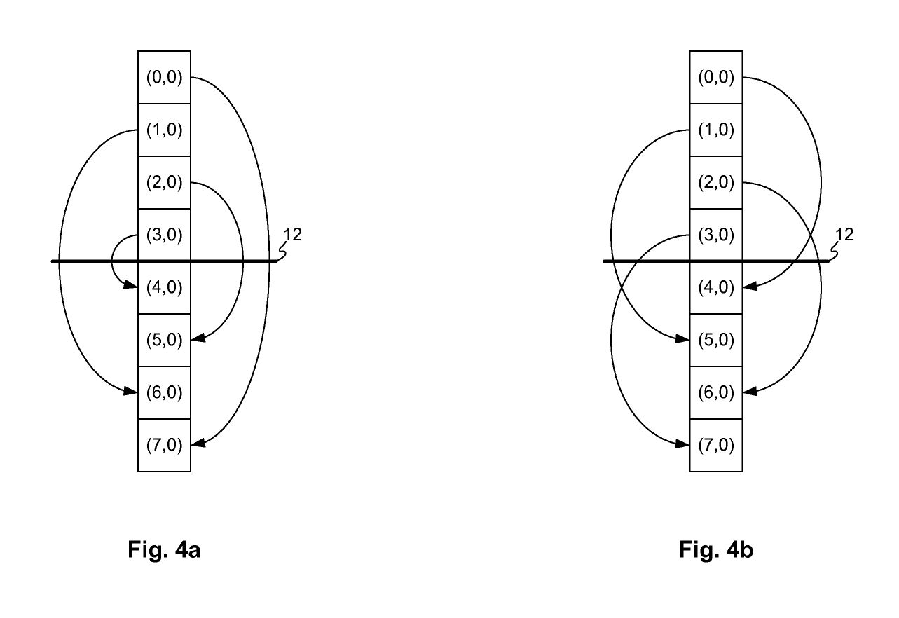

FIG. 4a illustrates a column of a frame for calculating a sum of absolute differences on the cells of the column. Generally, a cell in a first area of the frame is compared to a cell in a second area of the frame to determine how similar or dissimilar the first area is with the second area. In order to do this, for each column a sum of absolute differences (“SAD”) for the cells in the same column are calculated. The larger the SAD value for a column, the more likely the respective frame has 3D video data. Furthermore, all the SAD values from the other columns of the frame can be calculated and summed to generate a single SAD sum for the columns of the frame.

The SAD value is calculated by first calculating the differences between a cell in the first area and a cell in the second area that is in a mirror image position about the bisect line 12, and then repeating this step for all the cells in the first area. All the differences are summed up to get the SAD value for the column. For instance, a video characteristics of the cell (0,0) is subtracted with the video characteristics of the cell (7,0); the video characteristics of the cell (1,0) is subtracted with the video characteristics of the cell (6,0); the video characteristics of the cell (2,0) is subtracted with the video characteristics of the cell (5,0); and the video characteristics of the cell (3,0) is subtracted with the video characteristics of the cell (4,0). The video characteristics can be a single characteristic, for instance, the average luminosity for each cell. Thus, the subtracting of video characteristics of the cells can be a basis of comparing those cells, e.g., by subtracting the average luminosity of one cell with the average luminosity of another cell at a predefined position. The differences for the cells in that column are summed together to get a SAD value for that column of the frame.

FIG. 4b illustrates a column of a frame for calculating an inverse sum of absolute differences on the cells of the column. In addition, other cell positions can be compared to determine how similar or dissimilar the first area is with the second area. In order to do this, for each column an inverse sum of absolute differences (“ISAD”) for the cells in the same column are calculated. The smaller the ISAD value for a column, the more likely the respective frame has 3D video data. Furthermore, all the ISAD values from the other columns of the frame can be calculated and summed to generate a single ISAD sum for the columns of the frame.

The ISAD value is calculated by first calculating the differences between a cell in the first area and a cell in the second area that is disposed in the same position as the cell in the first area from the bisect line 12, and then repeating this step for all the cells in the first area. All the differences are summed up to get the ISAD value for the column. For instance, a video characteristics of the cell (0,0) is subtracted with the video characteristics of the cell (4,0); the video characteristics of the cell (1,0) is subtracted with the video characteristics of the cell (5,0); the video characteristics of the cell (2,0) is subtracted with the video characteristics of the cell (6,0); and the video characteristics of the cell (3,0) is subtracted with the video characteristics of the cell (7,0). The video characteristics can be a single characteristic, for instance, the average chroma for each cell. Thus, the subtracting of video characteristics of the cells can be a basis of comparing those cells, e.g., by subtracting the average chroma of one cell with the average chroma of another cell at a predefined position. The differences for the cells in that column are summed together to get the ISAD value for that column of the frame.

The SAD and ISAD value for the columns of the frame can determine whether the frame has 3D content packed in a top-bottom frame format. For instance, if the SAD value exceeds a first predefined threshold and the ISAD value is below a second predefined threshold, then a top-bottom frame format and 3D content can be detected for the television, or other display device, to initiate processing of such content in accordance with the top-bottom frame format. The first predefined threshold and the second predefined threshold can be found by empirical study. These thresholds can be varied depending on the video statistics used in the SAD and ISAD calculations. For instance, threshold values can be different for SAD and ISAD calculations based on color space statistics compared to threshold values for SAD and ISAD calculations based on edge or motion statistics.

Furthermore, the SAD and ISAD values for rows and columns can be used together to provide for a decision matrix to determine the reliability of the 3D content detection and the type of frame format, if any. The decision matrix can weigh several video characteristics simultaneously, including color space information (e.g., YUV color space), horizontal edge information, vertical edge information, motion statistics, etc., in calculating SAD and ISAD values for cells of the frame.

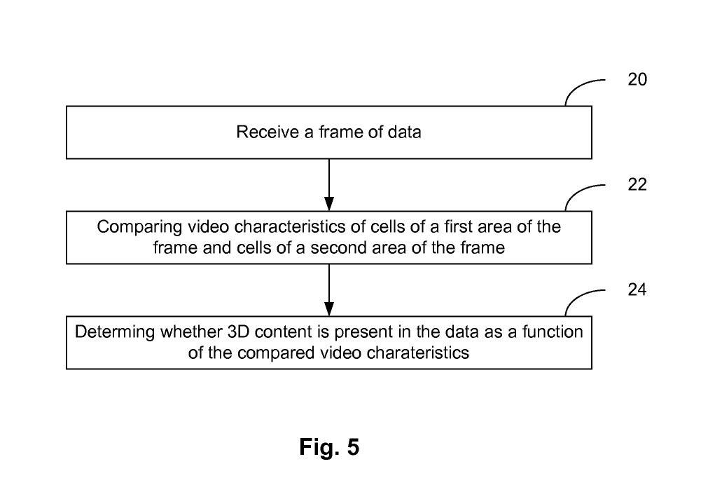

FIG. 5 illustrates a method of the present invention for determining whether 3D content is packed in video data. A television or other display device can receive a frame of data 20. Typically, a television can receive data via an over-the-air broadcast, and demodulate that data into a frame of video data. The video characteristics of cells of the frame are compared 22 to determine whether there is 3D content in the frame and what type of frame format is used, if any. The comparison can be done by breaking the frame into two areas, either by bisecting the frame along a vertical and/or a horizontal bisection line, and then performing SAD and ISAD calculations for the frame rows and columns, as illustrated above. The SAD and ISAD values can then be used to determine whether 3D content is present and the type of frame format 24 used.

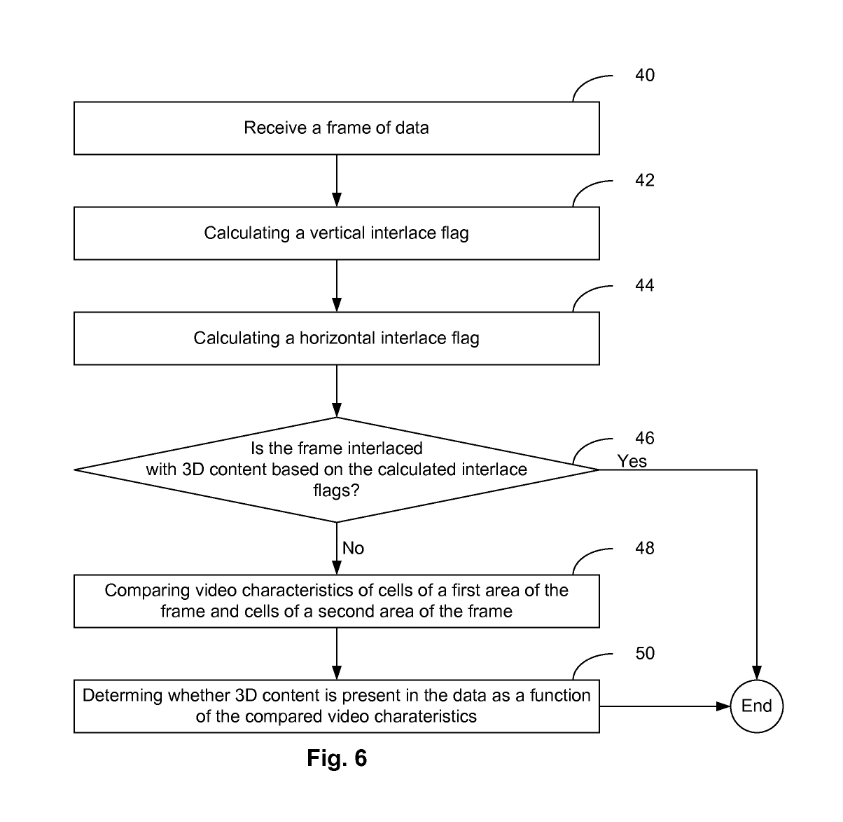

FIG. 6 illustrates a method of the present invention for determining whether 3D content is interlaced into video data. For other types of frame formats, e.g., row interlaced, column interlaced, checkerboard interlaced, etc., the above methods may not be best suited to detect such frame formats since those methods average a cell of the frame that may have both views for the 3D content. In such situations, another method of the present invention can be used to determine whether 3D content is present and the type of the frame format used, if any.

A television or other display device can receive a frame of data 40. The television can receive data via an over-the-air broadcast, and demodulate that data into a frame having pixels in an i by j (“i×j”) array format.

A vertical interlace flag can be calculated 42 to determine whether the columns of the frame are interlaced with a first view and a second view of an image or video. The vertical interlace flag can be calculated by determining a SAD value, Ver_{—}2^{nd} value, for pixels that are in the same column but two rows away from each other in the frame, for all pixels in the frame, and by determining a SAD value, Ver_{—}1^{st} value, for pixels that are in the same column but one row away from each other in the frame, for all pixels in the frame. Next, if the Ver_{—}2^{nd} value is less than the Ver_{—}1^{st} value times a predefined value alpha, then the vertical interlace flag is initialized to indicate that the frame may be vertically interlaced. If the frame is vertically interlaced, then the first view and the second view for the 3D content can be interlaced in each column of the frame. The predefined value alpha can be less than one and be found through empirical analysis.

A horizontal interlace flag can be calculated 44 to determine whether the rows of the frame are interlaced with a first view and a second view of an image or video. The horizontal interlace flag can be calculated by determining a SAD value, Hor_{—}2^{nd} value, for pixels that are in the same row but two columns away from each other in the frame, for all pixels in the frame, and by determining a SAD value, Hor_{—}1^{st} value, for pixels that are in the same row but one column away from each other in the frame, for all pixels in the frame. Next, if the Hor_{—}2^{nd} value is less than the Hor_{—}1^{st} value times a predefined value, then the horizontal interlace flag is initialized to indicate that there may be horizontally interlaced 3D content along each row of the frame. The predefined value beta can be less than one and be found through empirical analysis.

Next, based on the calculated interlace flags, we can determine if the frame is interlaced with 3D content 46 either vertically, horizontally, or in a checkerboard pattern. For instance, if the vertical interlace flag is initialized and the horizontal interlace flag is not initialized, the frame can be detected as vertically interlaced, and processed according. If the vertical interlace flag is not initialized and the horizontal interlace flag is initialized, the frame can be detected as horizontally interlaced, and processed according. Alternatively, if the vertical interlace flag is initialized and the horizontal interlace flag is initialized, the frame can be detected as interlaced in a checkerboard pattern, and processed according. Otherwise, the 3D content may not be interlaced in one of these frame formats. Thus, the frame is further processed to determine whether the frame has a side-by-side frame format, a top-bottom frame format, or is in a 2-D frame format.

For detecting whether the frame has another frame format, the video characteristics of cells of a first area of the frame and cells of a second area of the frame are compared 48 (see above for more details). Next, the frame can be determined to have 3D content as a function of the compared video characteristics 50, and processed accordingly.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred apparatuses, methods, and systems described herein, but all those other and further alterations and modifications as would be apparent to those of ordinary skilled in the art.

We claim:

1. A method for 3D content detection, comprising the steps of:
receiving a frame of video data comprising cells, wherein the cells are partitioned into a first area and a second area, and wherein the cells of the first area and the cells of the second area have one or more video characteristics;
comparing the video characteristics of the cells of the first area with the video characteristics of the cells of the second area; and
determining whether the frame has 3D content as a function of the compared video characteristics of the cells.

2. The method of claim 1 in the comparing step, wherein a sum of the absolute differences (“SAD”) between the video characteristics of the cells of the first area and the video characteristics of the cells of the second area is calculated, and, in the determining step, wherein whether the frame has 3D content is determined as a function of the SAD.

3. The method of claim 1 in the comparing step, wherein an inverse sum of the absolute differences (“ISAD”) between the video characteristics of the cells of the first area and the video characteristics of the cells of the second area is calculated, and, in the determining step, wherein whether the frame has 3D content is determined as a function of the ISAD.

4. The method of claim 1 in the comparing step, wherein a sum of the absolute differences (“SAD”) between the video characteristics of the cells of the first area and the video characteristics of the cells of the second area is calculated and wherein an inverse sum of the absolute differences (“ISAD”) between the video characteristics of the cells of the first area and the video characteristics of the cells of the second area is calculated, and, in the determining step, wherein whether the frame has 3D content is determined as a function of the SAD and the ISAD.

5. The method of claim 2 wherein the SAD is calculated by summing the absolute differences of a video characteristic between each one of the cells of the first area in a first row and a mirror counterpart cell of the second area in the first row.

6. The method of claim 3 wherein the ISAD is calculated by summing the absolute differences of a video characteristic between each one of the cells of the first area in a first row and a counterpart cell of the second area in the first row that has the same position in the second area relative to the bisection.

7. The method of claim 2 wherein the SAD is calculated by summing the absolute differences of a video characteristic between each one of the cells of the first area in a first column and a mirror counterpart cell of the second area in the first column.

8. The method of claim 3 wherein the ISAD is calculated by summing the absolute differences of a video characteristic between each one of the cells of the first area in a first column and a counterpart cell of the second area in the first column that has the same position in the second area relative to the bisection.

9. The method of claim 1 wherein the video characteristics comprises one or more of the following: average luma, average color, average motion detection, and or average edges.

10. A method for 3D content detection, comprising the steps of:
receiving a frame of video data having pixels disposed along an array of m rows and n columns;
calculating a vertical interlace flag;
calculating a horizontal interlace flag; and
determining whether the frame is interlaced with 3D content as a function of the calculated vertical interlace flag and the calculated horizontal interlace flag,
wherein if the frame is determined to not have interlaced 3D content, then
partitioning the frame into a first area and a second area, wherein the first area comprises one or more cells and the second area comprises one or more cells, and wherein the cells of the first area and the second area have one or more video characteristics;
comparing the video characteristic of the cells of the first area with the video characteristics of the cells of the second area; and
determining whether the frame has 3D content as a function of the compared video characteristics of the cells.

11. The method of claim 10 in the calculating the vertical interlace flag, wherein a first sum of absolute differences (“SAD”) is calculated between adjacent pixels along the same column, wherein a second SAD is calculated between every other pixel along the same column, and wherein the first SAD and the second SAD are compared to determine whether the frame is vertically interlaced.

12. The method of claim 10 in the calculating the horizontal interlace flag, wherein a first sum of absolute differences (“SAD”) is calculated between adjacent pixels along the same row, wherein a second SAD is calculated between every other pixel along the same row, and wherein the first SAD and the second SAD are compared to determine whether the frame is horizontally interlaced.

13. A method for 3D content detection, comprising the steps of:
receiving a frame of video data comprising cells, wherein the cells are partitioned into a first area and a second area, and wherein the cells of the first area and the cells of the second area have one or more video characteristics;
comparing the video characteristics of the cells of the first area with the video characteristics of the cells of the second area, wherein a sum of the absolute differences (“SAD”) between the video characteristics of the cells of the first area and the video characteristics of the cells of the second area is calculated, and wherein an inverse sum of the absolute differences (“ISAD”) between the video characteristics of the cells of the first area and the video characteristics of the cells of the second area is calculated; and
determining whether the frame has 3D content as a function of the SAD and the ISAD.

14. The method of claim 13 wherein the SAD is calculated by summing the absolute differences of a video characteristic between each one of the cells of the first area in a first row and a mirror counterpart cell of the second area in the first row.

15. The method of claim 13 wherein the ISAD is calculated by summing the absolute differences of a video characteristic between each one of the cells of the first area in a first row and a counterpart cell of the second area in the first row that has the same position in the second area relative to the bisection.

16. The method of claim 13 wherein the SAD is calculated by summing the absolute differences of a video characteristic between each one of the cells of the first area in a first column and a mirror counterpart cell of the second area in the first column.

17. The method of claim 13 wherein the ISAD is calculated by summing the absolute differences of a video characteristic between each one of the cells of the first area in a first column and a counterpart cell of the second area in the first column that has the same position in the second area relative to the bisection.

18. The method of claim 13 wherein the video characteristics comprises one or more of the following: average luma, average color, average motion detection, and or average edges.

19. The method of claim 13 further comprising the steps, after the receiving step and before the comparing step, of:
calculating a vertical interlace flag;
calculating a horizontal interlace flag; and
determining whether the frame is interlaced with 3D content as a function of the calculated vertical interlace flag and the calculated horizontal interlace flag, wherein the frame of video data having pixels disposed along an array of m rows and n columns.

20. The method of claim 19 in the calculating the vertical interlace flag, wherein a first sum of absolute differences (“SAD”) is calculated between adjacent pixels along the same column, wherein a second SAD is calculated between every other pixel along the same column, and wherein the first SAD and the second SAD are compared to determine whether the frame is vertically interlaced and in the calculating the horizontal interlace flag, wherein a first sum of absolute differences (“SAD”) is calculated between adjacent pixels along the same row, wherein a second SAD is calculated between every other pixel along the same row, and wherein the first SAD and the second SAD are compared to determine whether the frame is horizontally interlaced.
